(19) United States
(12) Patent Application Publication
(10) Pub. No.: US 2010/0175607 A1
(43) Pub. Date: Jul. 15, 2010

(54) Floating Aquatic Platform Structure

(76) Inventors: Mathieu Vincent Millet, Paris (FR); Thierry Garcia, Rambouillet (FR)

Correspondence Address: Marc P. Schuyler, P.O. Box 2535, Saratoga, CA, 95070, US

(21) Appl. No.: 12/302,877

(22) PCT Filed: May 30, 2007
(86) PCT No.: PCT/FR2007/000896

§ 371 Date: Jul. 22, 2009

(30) Foreign Application Priority Data
May 30, 2006 (FR) 06/04834

(51) Int. Cl. B63B 35/73; B63B 17/00; E01D 1/00; B63B 17/02; F21V 33/00; B23P 17/04

(52) U.S. Cl. 114/361; 114/264; 114/362; 362/101; 29/428

(57) ABSTRACT

The invention concerns a floating aquatic platform structure including a transparent base, capable of accommodating pieces of furniture and people, and the means to keep it upright within an area of natural or man-made water. The aquatic platform is designed in the form of a rigid set of self-supporting frames (1,17,18) in a geometrically simple shape, grouped together by base modules (2) with a limited number of frames, each frame (1,17,18) supporting a transparent slab (15) inserted into said frame and whereby the means for keeping the aquatic platform on the surface include floats (8,9,10) placed on at least two opposite sides of the platform.

The invention concerns a floating aquatic platform structure designed for natural bodies of water (oceanfront or lagoons, lakes or rivers) or man-made bodies of water (swimming pools, ponds or canals), including in luxury resorts.

Building sub-aquatic or floating platform structures is a known process. The document US 2003-150368 discloses a sub-aquatic platform structure with an inflatable boot design allowing some flexibility to the structure. The document US 2004-058599 discloses a floating platform capable of being used alone or in combination with other similar platforms, and held rigid by support elements integrated into the platform. The document EP 0448877 discloses a floating platform composed of square or rectangular-shaped modules, assembled together using linking plates inserted within the angles of the modules and mounting elements passing through modules and plates.

The document U.S. Pat. No. 1,591,341 discloses a platform consisting of a sealed frame floor supporting transparent flat panels positioned on a non-horizontal plane. A moveable section of the floating platform is suspended by a hull structure so as to be in contact with the water, and is not adapted to accommodate people or pieces of furniture.

Most of the platforms known are therefore either flexible and always exclusively opaque, or translucent but with a relative rigidity, thus limiting their applications, in particular as a flooring structure just above the surface of the water allowing the observation of aquatic life via the transparent structure.

The invention is intended to offer an aquatic platform structure being sufficiently rigid and stable to allow the direct observation of aquatic life or to convey the sense of safely walking on the water in a living space such as a bar, a restaurant or a private terrace for relaxation purposes.

An object of the invention is an aquatic platform structure having a transparent base capable of accommodating people and pieces of furniture, and means for maintaining it floating on a natural or man-made body of water, wherein the aquatic platform is designed in the form of a rigid set of self-supporting frames of geometrically simple shape, grouped together by base modules of a limited number of frames, each frame supporting a transparent flat surface inserted therein, and wherein the means for keeping the aquatic platform afloat include floats or pontoons placed on at least two opposite sides of the platform.

Preferably, the floats are spaced at the periphery of the platform.

Additional floats are favorably arranged under said floats, in the immediate vicinity of angles of the structure.

Preferably, the number of frames for each base module is selected from the set of values [(n)²] or [2.(n)].

A limited number of base modules is favorably arranged on a supporting frame comprised of beams, the outer dimensions of the supporting frame matching those of the group of limited number of base modules, with at least one medium beam within the supporting frame.

Preferably, frames and beams for the supporting frame are obtained from a folded metal sheet aimed to form a hollow body.

The floating elements are favorably rigid, and equipped with wheels allowing ground motion; they are covered with a wood-based material on all the visible parts.

The structure favorably comprises a lighting system to delineate the structure of the aquatic platform, and secondly, to enhance illumination for the observation of aquatic life through the transparent flat elements.

Preferably, the structure comprises a ramp as a passageway, constituted with transparent flat elements on base frames, and surrounded or not by floating elements covered with wood material.

The floating elements are favorably mounted on moveable metallic frame ensuring a height adjustable placement of the platform.

Preferably, the transparent slabs are moveable and reversibly mounted using a U-shaped joint on the periphery of the low thickness section in the surface.

The platform has favorably a protective fabric-based construction designed to protect against permanent exposure to the sun.

This invention is described below in reference to the attached drawings in which:

FIG. 1 represents a perspective view of a basic, self-supporting frame for an aquatic platform according to the invention;

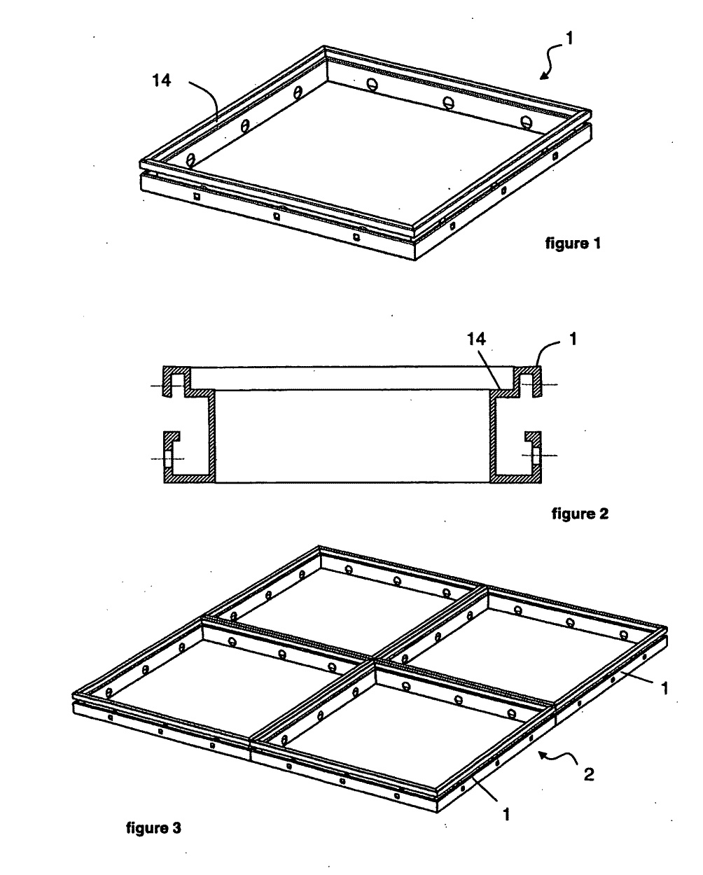

FIG. 2 is a vertical cross-sectional view of the middle of the frame of FIG. 1;

FIG. 3 represents a perspective view of a base module composed of a restricted number of frames of FIG. 1;

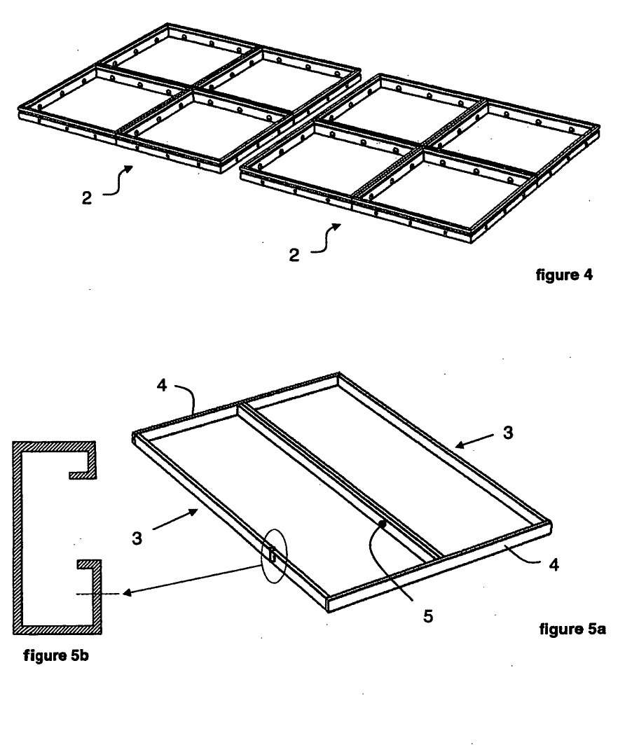

FIG. 4 represents a perspective view of an assembly of a plurality of base modules of FIG. 3;

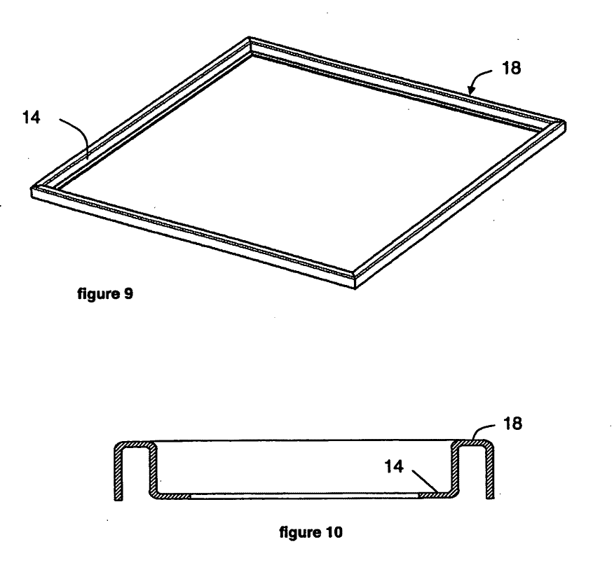

FIG. 5a represents a perspective view of a supporting frame forming a floor of supporting frames of FIG. 9 arranged according to the assembly of FIG. 3;

FIG. 5b represents a cross-sectional view of the middle of a beam from the frame of FIG. 5a;

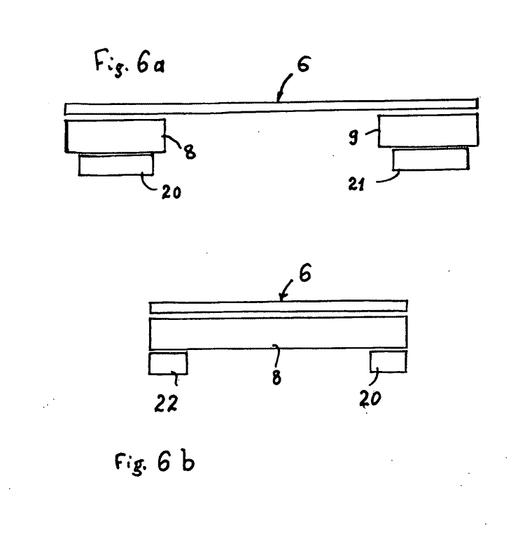

FIG. 6a represents a vertical longitudinal section of an example of an aquatic platform structure according to one embodiment of the invention;

FIG. 6b represents a vertical cross-sectional view of an aquatic platform structure according to FIG. 6a;

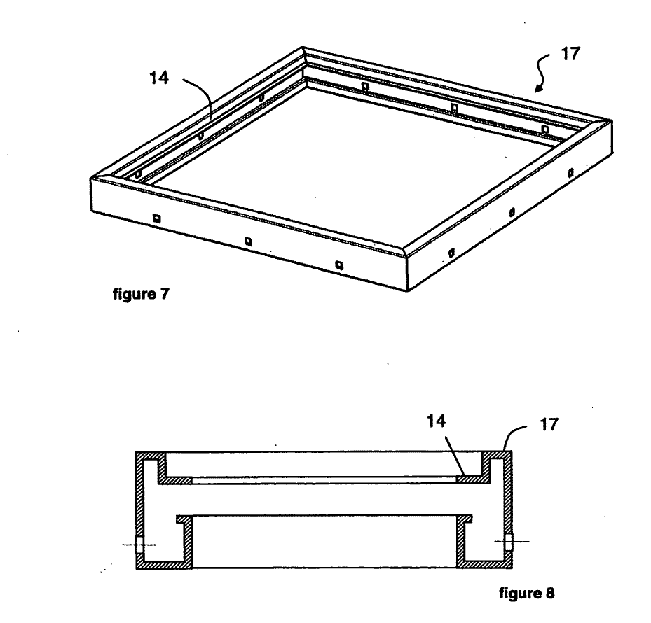

FIG. 7 represents a perspective view of another embodiment of a self-supporting basic frame according to the invention;

FIG. 8 represents a vertical cross-sectional of the middle of the frame of FIG. 7;

FIG. 9 represents a perspective view of a third embodiment of a basic frame according to the invention;

FIG. 10 is a vertical cross-sectional view of the middle of the frame of FIG. 9;

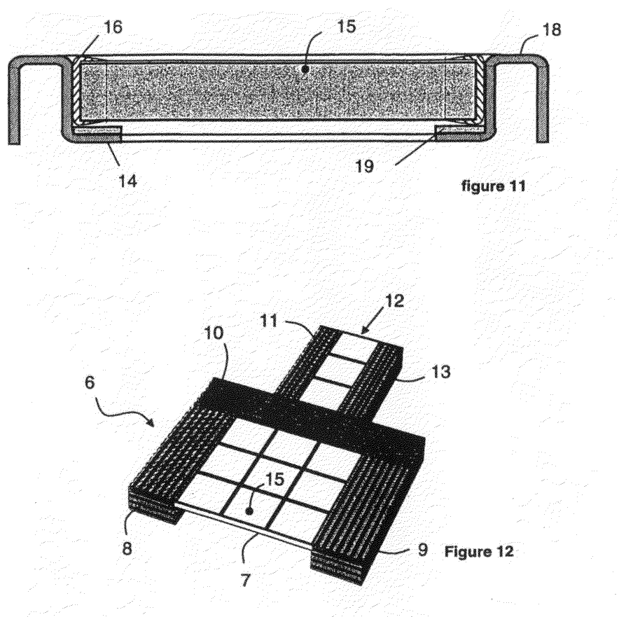

FIG. 11 represents in a sectioned view a basic frame of FIG. 9 and a transparent slab inserted therein with its peripheral sealing joint.

FIG. 12 represents a perspective view of an aquatic platform structure according to the invention equipped with a floating ramp as a passageway.

FIGS. 1 and 2 represent a basic self-supporting frame 1 in a generally square form. This frame is favorably composed of a folded metallic sheet aimed to form a hollow body profile, open outwards in the example of the embodiment presented. The frame 1 is of a metal material, rigid, and intended to accommodate a transparent slab, in glass or plastic material, forming the useable surface of the transparent floor of the aquatic platform and aimed to support significant loads. The slab is supported within the frame 1, which has on its inner profile an inner supporting corner 14 for the slab. To prevent occurrence of natural condensation or wear on the surface, which can affect the transparent material of the slab, it is preferable to have a thick slab composed with at least two stacked laminated glass sheets, moveable in the simplest fashion possible. Thus, the glass slab can be easily maintained by periodically turning it over, ensuring a lifetime longer by equally using both of its sides.

For this embodiment, the glass slab 15 (FIG. 11) is provided with a U-shaped peripheral joint 16 on its edge allowing a fitting condition inside the frame and a support on the inner edge 14 of the frame, itself equipped with a flat gasket 19 all around it. In addition to the sealing need of the multi-layered glass slab, the combination of joints 16 and 19 provide a protection against shock and an elastic support surface on the metallic frame without any risk of damage to the slab. Thus, this glass slab is removable and reversible in order to ensure the transparent aspect thereof.

The basic self-supporting frame 1 is designed to offer a great rigidity while occupying a minimum of the horizontal surface of the aquatic platform allowing the maximum of the transparent surface to be kept for observing the aquatic life through the transparent slab.

The basic frame is favorably composed of a metallic section from a folded metal sheet in which the corner is directly folded to be used as a support of the transparent slab. The basic frames are assembled to form base modules of a limited plurality of frames which can constitute a self-supporting floor of an aquatic platform. The limited number is preferably 4, 6, or 9, in order to compose square modules (4 or 9 frames) or rectangular modules (6 frames) that are sufficiently rigid. In a base module, frames are joined together using nuts, for example, then the platform is obtained by inserting transparent slabs inside the assembled frames. FIG. 3 represents a base module 2 comprising four frames 1 to create a first layer of self-supporting floor.

In FIG. 4, two base modules 2 are shown comprised of four frames each. These modules 2 are placed side by side but not necessarily fixed together. However, in some applications, they could be mounted together or directly placed on a second layer of self-supporting floor.

In one example characteristic of this embodiment of the aquatic platform, the two base side by side modules 2 of FIG. 4 will be supported by a supporting frame 3 as shown in FIG. 5a. The supporting frame 3 is composed with beams assembled together to form firstly a outer frame 4 whose dimensions are matching the ones of the two base modules assembly 2 to be supported, and secondly, a central beam 5, longitudinal as shown in example of FIG. 5a, but which could alternatively be a crossbar. This beam 5 is placed under an assembly line of basic frames 1, 17, or 18 in order not to alter position of the surface existing under the transparent slabs meant to observe the aquatic life. A supporting frame is intended to accommodate a limited number of modules, preferably 2, 3, or 4 base modules to form a bearing floor preferably in combination with frames 18.

In FIG. 5b, beams are favorably made of a metallic sheet folded to form a hollow body profile, generally of a rectangular section, open on one side as shown in the example of the disclosed embodiment.

In FIGS. 7 and 8, the basic self-supporting frame 17 is obtained from a folded metal sheet, to form a hollow body profile, inwardly open as shown in the example of the disclosed embodiment. Frame 17 presents on its inner section, a supporting corner 14, obtained directly from folding process, for the glass slab.

FIGS. 9 and 10 represent a basic frame 18 being supported by a supporting frame 3. Said frame 18 is made of a folded metal sheet. The cross-section of the frame 18 is essentially comprised of a reversed u-shape piece and, inwardly to the frame, a supporting corner 14, obtained directly from the folding process, for the transparent slab.

The frame 18 is favorably mounted on a supporting frame such as 3, to achieve mechanical and structural strength equal to that of a self-supporting frame, such as 1 or 17.

The supporting frame 3 constitutes the second layer of the floor for the aquatic platform, the first layer being composed of base modules 2. Then, two types of frames can be favorably applied, one possibly being a self-supporting frame 1 or 17 for a single layer floor, the other a frame 18 placed on a multilayered bearing floor.

The goal is to create an aquatic platform as modular as practical in the three-dimensional space around a basic floor composed of at least one single frame, and at least one additional thickness to ensure the desired surface expansion needed and the support of loads.

In the case where the platform is of a large size or a high load, it can thus be useful to consider having a third layer of floor in the form of a base comprised of beams assembled to form a larger sized-frame with dimensions corresponding to a group of supporting frames 3, provided with at least one cross beam located under beams or cross beams of supporting frames 3, in a manner that does not unreasonably modify the surface available under the transparent slabs for observing the aquatic life.

The objective is thus to obtain a rigid grid made of stacked floors from the maximum dimensions of a basic frame to obtain a greater modular aspect of the aquatic platform. Additionally, building up floors should not be performed to the detriment of the maximum view possible of the aquatic life.

FIG. 12 represents a floating aquatic structure according to one embodiment of the invention. Said aquatic platform 6 comprises a base module 7 of nine frames 1 in the example disclosed. The base module 7 is surrounded on the 3 sides by floating elements 8, 9, 10.

Said floating elements are rigid, favorably made of a plastic material and are provided with wheels for ground motion. They are preferably covered, on top and sideways, with a wood-based covering. For this, a metallic framing is available to mount the floating assembly, defining a free space between the floating assembly and the wood-based covering. Thus, air, water or gas systems, not visible, can be arranged on the floating assembly for port-based or floating habitations applications, and more specifically a power system for purposes of lighting or illuminating the platform. An attractive audio-based ambiance device can be installed into the wooden framework to accentuate the sense of relaxation.

Additionally, the wood-based covering may be replaced due to wear, as well as the replacement of sections affected by sun exposure, or water immersion or naturally spoiled with the development of algae or incrustation of crustaceans. Moreover, this wood-based covering conceals from view any damage made to the floating elements.

FIGS. 6a and 6b represent the arrangement of the floating elements 8 and 9 surrounding the aquatic platform 6 on its lateral sides in the disclosed example. To increase floatability and stability of platform 6, additional floating elements 20 and 23 are arranged under the primary floating elements 8, 9, in the close vicinity of the angles of the structure to locally increase floatability. The floatability distribution thus does not have to be even, but may be judiciously organized to improve the stability of the platform in case of a concentration of weight on critical end points of the diagonal planes formed by the four corners of the platform.

Thus, the structure of the transparent floor for the floating platform is able to accommodate a significant number of persons due to the increase of overall floatability while accepting the movement of a group of people without greatly disturbing the assembly stability. A waterproof lighting system can be installed for one part, inside the basic frames 1, and on the wood-based covering of the floating elements to delineate the aquatic platform structure, and otherwise under the aquatic platform structure, to illuminate the aquatic life observed through the transparent slabs. For said aquatic life illumination, the lighting system is installed below the waterline, on or under the wood-based covering of the floating elements. The goal is to create both ambient and safety lighting according to the position of the platform above the water, including at night.

The aquatic platform structure is favorably attached to anchoring elements in the water and/or in the ground, or to a pontoon, using an access ramp 11, articulated with the structure or juxtaposed on its own floating elements with a non-rigid ramp in liaison with the structure. This ramp 11 may include a passageway 12, comprised of basic frames 1 with transparent slabs, attached to each other in a rigid fashion, and surrounded or not by floating element 13 with wheels allowing it ground motion.

The aquatic platform structure is by nature rigid, and the platform lies above the water. The basic self-supporting elements 1 or 17 are rigidly attached together in base modules 2. In the event where supporting frames 3 are used, the base modules 2 of basic frames 18 they are supporting are firmly attached to the frames 3 and said frames 3 are rigidly attached together. The floating elements are rigidly attached to the base modules 2 or to the frames 3, and to each other. The structure may be used thus as a living or relaxing space by its users, as it is capable of accommodating pieces of furniture and people for food and spa purposes. To protect the platform components and the users from sun exposure for an extended period of time, a fabric-based roof structure can be added to ensure a shaded area. Of course, for child safety purposes, rails should be placed around the entire periphery of the platform and along the sides of the access ramp.

The platform can be used as a luxury residence private pier during any nautical activities, such as diving, water-skiing or jet-skiing, or for any other marina-based activity.

Moreover, a plurality of transparent floor-based aquatic platforms 6 can be connected to each other to form as many structure configurations for individual or collective aquatic-based spaces. Thus, from a platform surface given, it is possible to create a floating architecture, attached to each other with floating access ramps or not. The association of a plurality of single-based structures forms an extended surface without lowering the average load capacity.

One or more accesses can be favorably arranged around the platform to facilitate the individual traffic or accommodation.

Though the invention has been described in relation to specific embodiments, it should be understood that it is not limited by these embodiments, but it includes all technical equivalents of the means previously described, as well as any combinations thereof within the scope of the invention.

1-13. (canceled)

14. An aquatic platform, comprising:
a transparent floor to accommodate furniture and people; and
a flotation mechanism to keep the structure afloat on a body of water;
where the aquatic platform includes at least one base module comprising a rigid assembly of flooring frames of geometrically simple form, each flooring frame supporting a transparent floor member inserted into said frame;
wherein the flotation mechanism includes at least two floats, including at least one float placed in proximity to each of at least two opposite sides of the platform.

15. The platform of claim 14, where the floats are positioned at a periphery of the platform.

16. The platform of claim 14, where additional floating elements are placed under said floats, at least in a region associated with at least one corner of the platform.

17. The platform of claim 16, where in that the number of frames of each base module is selected from the group of values consisting of N² or 2N, where N is an integer.

18. The platform of claim 14 where:
the platform further comprises a plurality of said base modules, arranged in a configuration, and a supporting frame having dimensions matched to the configuration, to structurally support the plurality of said base modules; and
the supporting frame further includes at least one transverse beam (5) acting as a joist to support at least two base modules within the supporting frame.

19. The platform of claim 18, where the supporting frame includes at least one beam formed from a metal sheet folded to form a hollow body.

20. The platform of claim 14, where each flooring frame includes at least one beam formed from a metal sheet folded to form a hollow body.

21. The platform of claim 14, where the floatation mechanism includes wood-based covering adapted to conceal at least above-water portions of said floats.

22. The platform of claim 14, further comprising a lighting system adapted to illuminate aquatic life.

23. The platform of claim 14, further comprising an access ramp comprising a plurality of said flooring frames.

24. The platform of claim 14, where the flotation mechanism includes a height adjustment mechanism adapted to adjust height of the transparent floor with respect to a water surface.

25. The platform of claim 14, where the transparent floor members are removable and reversible.

26. The platform of claim 25, further comprising a U-shaped end element mounted to an edge of at least one transparent flooring member, to serve as a reversible interface between said at least one transparent flooring member and a corresponding flooring frame.

27. The platform of claim 14, further comprising a protective fabric covering to protect against permanent exposure to sun.

28. The platform of claim 14, further comprising an above-water lighting system.

29. An aquatic platform, comprising:
a support frame to form a first floor layer;
a plurality of flooring modules to be supported by the support frame, each flooring module having a peripheral frame and a transparent floor member supported by the peripheral frame, the plurality of flooring modules adapted for interconnection to thereby form a second floor layer mounted above the first floor layer; and
a floatation mechanism to support the aquatic platform so as to maintain at least the second floor layer at or above water level, the floatation mechanism operatively coupled to at least one of the first floor layer or the second floor layer.

30. The platform of claim 29, further comprising an underwater lighting system.

31. The platform of claim 29, wherein each flooring module is polygonal in shape.

32. The platform of claim 29, where each transparent floor member is formed substantially of glass.

33. The platform of claim 29, where each transparent floor member is formed substantially of a transparent plastic material.

34. A method of constructing an aquatic platform, comprising:
mounting a support frame to a floatation mechanism to form a base layer;
constructing a plurality of base modules, each base module forming a rigid member formed of a plurality of flooring modules, each flooring module having a substantially transparent floor mounted to a flooring frame, the base modules formed through interconnection between the flooring frames; and
mounting the plurality of base modules to the support frame.
